(19) United States
(12) Patent Application Publication
(10) Pub. No.: US 2025/0038598 A1
(43) Pub. Date: Jan. 30, 2025

(54) ELECTRIC MOTOR, POWER TOOL AND SYSTEM COMPRISING A POWER TOOL AND AN ENERGY SUPPLY DEVICE

(71) Applicant: Hilti Aktiengesellschaft, Schaan (LI)

(72) Inventors: Markus HARTMANN, Mauerstetten (DE); Torsten ASMUS, Kaufbeuren (DE); Stefan SCHWARZ, Landsberg (DE); Robert STANGER, Kaufbeuren (DE); Pierre PALLMER, Igling (DE); Simon STEENTJES, Buchloe (DE); Stefan HEROLD, München (DE); Christian RUFF, Stadtbergen (DE)

(21) Appl. No.: 18/713,903

(22) PCT Filed: Nov. 11, 2022
(86) PCT No.: PCT/EP2022/081630

§ 371 Date: May 28, 2024

(30) Foreign Application Priority Data
Dec. 1, 2021 (EP) 21211607.3

(51) Int. Cl. H02K 3/18; B25F 5/00; H02K 7/14

(52) U.S. Cl. CPC H02K 3/18; H02K 7/145; B25F 5/008

(57) ABSTRACT

An electric motor, in particular for a power tool, the electric motor having a stator with an inner opening for receiving a rotor. The inner opening has a diameter corresponding to an inner diameter of a stator, the stator having a series of pole teeth, which are each wound with a winding to form a coil. The winding is characterized by a reference diameter, a ratio of the reference diameter to the stator inner diameter multiplied by a number of pole teeth being greater than 0.3. Taking into account the internal resistance of an energy storage cell of an energy supply device of a maximum of 10 milliohms, the ratio of the diameters may be greater than 0.03 (milliohms)⁻¹. Also provided is an electric motor, in particular for a power tool, a ratio being formed from a sum of total winding conductor cross sections and a free winding cross section, the ratio being multiplied by a number of pole teeth and the product being greater than 2.2. Taking into account the internal resistance of an energy storage cell of the energy supply device of a maximum of 10 milliohms, the ratio of the areas of the cross sections may be greater than 0.22 (milliohms)⁻¹. Also provided is a power tool with one of the electric motors, and a system including a power tool and an energy supply device.

The present invention relates to an electric motor, in particular for a power tool, the electric motor having a stator with an inner opening for receiving a rotor. In further aspects, the invention relates to a power tool with one of the electric motors, and a system comprising a power tool and an energy supply device.

### BACKGROUND OF THE INVENTION

The invention is in the technical field of cordless power tools. Cordless power tools can be connected to an energy supply device for supplying energy. The energy supply device may for example be formed as a rechargeable battery (or accumulator) or comprise such a rechargeable battery. Rechargeable batteries usually have a large number of energy storage cells, also called rechargeable battery cells, with the help of which electrical energy can be taken up, stored and given off again. If the rechargeable battery is connected to a power tool, the electrical energy stored in the energy storage cells can be supplied to a consumer within the power tool. For charging, that is to say filling the energy storage cells with electrical energy, the rechargeable battery is connected to a charging device, such as a charger, so that electrical energy can reach the energy storage cells. The consumer may be for example an electric motor of the power tool.

An electric motor is designed to convert electrical power into mechanical power. Electric motors usually generate rotating movements, the corresponding rotary movement being based on the forces of attraction and repulsion of magnetic fields that are generated in the area of the electric motor. In the prior art, such electric motors in which a movably mounted inner part—the rotor—can rotate in a stationary outer part—the stator—are known in particular. The stator preferably has an inner bore, in which the rotor can rotate. The stators of conventional electric motors have pole teeth and grooves, the pole teeth being able to be wound with a metal wire in order to produce an electromagnetically effective coil.

### SUMMARY OF THE INVENTION

The metal wire from which the coils are wound may run within the grooves and be wound around the pole teeth. The grooves may have a slit through which the wire can be inserted into the groove during the winding process. For production reasons, conventional electric motors are currently wound with relatively small effective total cross sections of the single winding conductors. This circumstance is due to the fact that the wire has to be guided through the slits during winding, so that the slits must for example have at least twice or three times the width of the wire diameter. The wire used usually has a comparatively small cross section, that is to say a comparatively small sectional area. When winding known electric motors, the space available in the grooves for the winding material cannot be optimally used in this way. This means that, when looking at the sectional representation mentioned, a comparatively large proportion of the total available winding area (“total winding area”) disadvantageously remains unused. This unused proportion of the total winding area is referred to in the sense of the invention as “empty stator area”. This is preferably that area or that proportion of the total winding area that makes no electromagnetic contribution to the drive of the electric motor.

Conventional electric motors, as are known from the prior art, have several disadvantages. On the one hand, the small cross sections of the metal wire used to wind the coils of an electric motor result in high power losses within the motor. This is especially true when the electric motor is used in a cordless, rechargeable battery-operated power tool to drive the power tool or its tool. Particularly high losses occur in particular when the power tool is supplied with electrical energy by an energy supply device and in the process high output currents flow. Due to the high power losses, on the one hand the efficiency of the electrical drive of the electric motor may deteriorate, which is undesirable from both ecological and economic aspects. On the other hand, the conductors or the metal wire may be heated up undesirably, and if necessary measures must be taken to dissipate the corresponding heat from the electric motor.

An unfavorable, that is to say large, ratio between the empty stator area and the total winding area may also have a negative effect on the cooling of the electric motor. In particular, insufficient heat dissipation may occur. For example, if the electric motor is enclosed-ventilated, the cooling efficiency may be reduced. If necessary, the reduced cooling efficiency can be counteracted by providing a larger volumetric flow of cooling air. However, this requires a larger installation space and a higher cooling capacity. In addition, there may be increased noise emissions.

If external ventilation is used to cool the electric motor, there may be poorer heat transfer from the coils to the outside of the electric motor, since the surrounding air or the surrounding gas or gas mixture is usually a poor thermal conductor.

For example, US 2018 0248 418 A1 discloses a stator of a rotating electric machine with an optimal filling ratio. Such motors are used in particular in compressors for vehicles, vehicles usually having a permanently installed battery which is not regularly replaced in order to be charged.

DE 10 2014 110 073 A1 discloses a vacuum pump comprising a pump rotor and an electric motor to drive it. The electric motor has a rotatable rotor and a stator, the stator being composed of a plurality of stator teeth in the manner of ring segments.

US 2020 0162 007 A1 describes a high-performance system that is supplied with electrical energy or power from a battery. As an exemplary embodiment of the system, a power tool can be driven by an electric motor, the energy supply being carried out by a battery pack.

It is an object of the present invention to overcome the deficiencies and disadvantages of the prior art described above and to specify an electric motor, in particular for a power tool, with which both the heat dissipation efficiency and the power efficiency are improved. In particular, the electric motor to be provided should be able to be well cooled and in the process drive the power tool efficiently without unnecessary losses. Another concern of the invention is to specify a particularly compact and spacesaving electric motor, so that a power tool equipped with it can also be formed as handy and compact. A further concern of the invention is to specify a system, the system comprising a power tool and an energy supply device.

According to the invention an electric motor, in particular for a power tool, is provided, the electric motor having a stator with an inner opening for receiving a rotor. The inner opening has a diameter corresponding to an inner diameter of a stator, the stator having a series of pole teeth, which are each wound with a winding to form a coil. The winding is characterized by a reference diameter, a ratio of the reference diameter of the winding to the stator inner diameter multiplied by a number of pole teeth being greater than 0.3. The stated ratio of the reference diameter to the inner stator diameter multiplied by a number of pole teeth greater than 0.3 has proven to be particularly advantageous when the electric motor is used in a battery-powered power tool, an energy supply device of the power tool being designed to deliver large constant currents, for example in a range of more than 50 amperes (A), preferably more than 70 A and most preferably of more than 100 A. Surprisingly, the electric motor can be cooled particularly well and efficiently, especially in such applications. In particular, the electric motor has high drive and heat dissipation efficiency with at the same time a high power density.

Tests have also shown that electric motors with a ratio according to the invention of (reference diameter/stator inner diameter number of pole teeth) of greater than 0.3 have a particularly high efficiency because any empty spaces within the stator of the electric motor are particularly well filled with electromagnetically active material or have a high degree of filling. As a result, the electric motor can be operated optimally and particularly efficiently from both ecological and economic aspects. In particular, the electric motor has a high degree of groove filling, since in the electric motor the grooves of the stator can be filled particularly effectively with the conductor material of the winding. It is preferred in the sense of the invention that an empty stator area can advantageously be filled with electromagnetically active material, such as the metal wire of the winding or a larger laminated core area, instead of air. As a result, an electric motor with a high level of efficiency can be advantageously provided.

It is provided according to the invention that the winding is characterized by a reference diameter. It is particularly preferred in the sense of the invention that the winding is characterized by a number of turns and the turns by a reference diameter. Since the winding is preferably formed by a number of turns, the winding or the resulting coil is characterized by a reference diameter.

It is preferred in the sense of the invention that the winding has at least one single conductor. This preferably means in the sense of the invention that at least one individual metal wire is used to form the coil by winding around a pole tooth of the stator (“single winding”). It may also be preferred in the sense of the invention that the winding is formed from a plurality of single conductors or that the winding comprises more than one single conductor (“multiple winding”). A coil can be produced by winding up at least one single conductor. A coil preferably comprises one or more turns, which may each be composed of one or more single conductors. The turn may have a total winding conductor cross section. If for example the single conductor from which the turn or coil is made has a square cross section, that is to say a square sectional area, then the total winding conductor cross section corresponds to the area of this square cross section. In other words, the total winding conductor cross section corresponds to the cross-sectional area of the single conductor. For example, if the single conductor from which the winding or coil is made has a circular or substantially circular cross section, that is to say a substantially circular sectional area, then the total winding conductor cross section corresponds to the area of this substantially circular cross section. The total winding conductor cross section preferably corresponds to the winding-relevant cross section of a single conductor. The total winding conductor cross section preferably corresponds in the case of a single winding to the cross section of the winding conductor, while the total winding conductor cross section in the case of a multiple winding preferably corresponds to the cross section of the plurality of winding conductors, that is to say the sum of the cross sections of the individual winding conductors.

The wording “substantially circular” is not unclear for a person skilled in the art, because a person skilled in the art knows that the wording also includes total winding conductor cross sections that have small deviations from a mathematically exact circular area. For example, in the context of the present invention, those total winding conductor cross sections that have small indentations or protuberances or production-induced notches or raised areas should also be regarded as “substantially circular”. The “substantially circular” total winding conductor cross sections are preferably distinguished from those total winding conductor cross sections that are based on a different basic geometrical shape or have a different geometrical base area. For example, conductors having a rectangular, square, elliptical, diamond-shaped, trapezoidal or triangular base area should not be considered to be conductors with a “substantially circular” cross section. Such conductors are preferably referred to in the sense of the invention as “conductors without a substantially circular cross section”. It is preferred in the sense of the invention that a cross section of a conductor is obtained by an imaginary section through the conductor. The term “conductor” or “single conductor” is used in the sense of the invention for the metal wire from which the winding of the electric motor is formed or wound. In this case, the winding may comprise a single conductor or a plurality of single conductors. It is preferred in the sense of the invention that the pole teeth of the stator of the electric motor are wound with the at least one conductor, so that a winding and in particular a coil is formed. The coil is preferably designed to generate a magnetic field when an electric current flows through it in a specific direction. When the direction of the current is changed, the orientation of the magnetic field generated by the coil also changes.

It is preferred in the sense of the invention that the reference diameter for a winding in which at least one single conductor does not have a substantially circular cross section is determined using a cross-sectional area of the single conductor, it being checked which diameter corresponds to the determined cross-sectional area on the assumption of a single conductor with a substantially circular cross section. If the winding comprises a plurality of single conductors or is formed from a plurality of single conductors, the reference diameter may correspond to a diameter corresponding to a sum of the cross-sectional areas of the single conductors. If multiple conductors are used to form the winding, the single conductors or single windings may preferably be connected in parallel to achieve a single-wound coil effect.

If for example a single conductor with a substantially circular cross section is used to produce or wind the coil, the diameter of the single conductor being for example 1 mm, then its base area is A=π/4·d²=π/4·mm². In this embodiment of the invention, the reference diameter would be 1 mm.

If for example two single conductors, each with a substantially circular cross section, are used to produce or wind the coil, the diameters being 1 mm each, the reference diameter in this exemplary embodiment of the invention is 1.41 mm.

If for example a single conductor with a non-circular cross section is used to produce or wind the coil, e.g. a single conductor with a square base area with an edge length of 1 mm, the reference diameter is determined with the help of the base area of the non-circular conductor The base area A of the square single conductor with an edge length of 1 mm is A=a²=1 mm². Using the formula A=π/4·d², this value for the base area A is then used to determine the reference diameter of a corresponding conductor with a substantially circular cross section. In the present case, the diameter of a corresponding conductor with a substantially circular cross section would be: d=√(4/π·A)=2·√(A/π)=2·0.564 mm=1.128 mm.

If for example two such single conductors with a square cross section with an edge length of 1 mm are used to produce or wind the coil, the reference diameter in this exemplary embodiment of the invention is 1.6 mm.

In these calculations of the reference diameter, a fictitious replacement diameter is preferably calculated, preferably referred to in the sense of the invention as the “reference diameter”. By using this reference diameter, different cross-sectional shapes and multiple windings, that is to say windings of the coils with more than one conductor, can be shown particularly well and compared with one another.

It is preferred in the sense of the invention that the terms “reference diameter” and “equivalent winding conductor diameter D_ÄQUI” are used synonymously in the context of the present invention. It is preferred in the sense of the invention that the total winding conductor cross section can be converted into the reference diameter or the equivalent winding conductor diameter D_ÄQUI using the following formula: D_ÄQUI=(4· total winding conductor cross section/π)\hat{ }0.5. The equivalent winding conductor diameter therefore preferably corresponds to the square root of the term in parentheses. The equivalent winding conductor diameter D_ÄQUI preferably corresponds to a result of the conversion of the total winding conductor cross section into a fictitious replacement diameter, with which different cross-sectional shapes that can occur in winding conductors can be compared particularly well with a substantially circular, “round” single conductor.

The pole teeth of the stator of the electric motor are the elements of the electric motor to which the at least one winding can be applied. The pole teeth may comprise laminated cores and are preferably also referred to in the sense of the invention as “stator teeth”. The stator also has an inner opening, in which the rotor of the electric motor can usually move, that is to say rotate. The inner opening has a diameter which corresponds to a stator inner diameter. It is preferred in the sense of the invention that the inner opening of the stator corresponds to an inscribed circle of the stator. The inner stator diameter may preferably correspond to the diameter of the inscribed circle. The inner stator diameter preferably corresponds to a diameter of the inscribed circle of the inner opening of the stator. This applies in particular when the inner opening of the stator has a non-circular basic shape. If the inner opening of the stator has a substantially circular basic shape, the inscribed circle and the inner circle of the stator preferably coincide or the inscribed circle and the inner circle of the stator are congruent. In the sense of the invention, the inscribed circle preferably corresponds to a largest circle that can be placed in a non-circular, closed shape. The inner opening of the stator may preferably also be referred to in the sense of the invention as the stator bore.

The stator of the electric motor may preferably comprise a preferably ferromagnetic core, this preferably ferromagnetic core being able to be formed as one or more parts. If the electric motor or its stator is viewed in a sectional representation in a plane of which the surface normal corresponds to an axis of rotation of the electric motor, there may appear a cross section of the stator, or the preferably ferromagnetic core, which preferably includes non-ferromagnetic areas, which are preferably also referred to in the sense of the invention as “empty stator areas”. This may be on the one hand the inner opening of the stator and on the other hand, areas for receiving the winding. It is preferred in the sense of the invention that the area of the inner opening of the stator can be subtracted from the total empty stator area in order to obtain an adjusted empty stator area. This adjusted empty stator area can be divided by the number of pole teeth, and this division can be used to determine a measure of the area inside the rotor that is available for the winding and any insulation or insulating means. By dividing by the number of pole teeth, in particular a so-called “free winding cross section” is obtained, that is to say an area that is available per winding or per pole tooth. If the stator comprises for example six pole teeth, the stator preferably also has six free winding cross sections, which are preferably also referred to in the sense of the invention as grooves. The grooves or free winding cross sections are preferably arranged between two pole teeth each, approximately half of a free winding cross section being available for winding around the one adjacent pole tooth and the other half for winding around the other adjacent pole tooth.

This free winding cross section can be related to a sum of the total winding conductor cross sections, the sum of the total winding conductor cross sections preferably corresponding to the sum of the total winding conductor cross sections in a winding window. The winding window preferably corresponds to the sectional area of a groove in the sectional representation of which the surface normal corresponds to an axis of rotation of the electric motor.

In a second aspect, the invention relates to an electric motor, in particular for a power tool, the electric motor having a stator with an inner opening for receiving a rotor, the inner opening having a diameter which corresponds to a stator inner diameter, the stator having a series of pole teeth, which are each wound with a winding to form a coil. A ratio is formed from a sum of the total winding conductor cross sections and a free winding cross section, the ratio being multiplied by a number of pole teeth and the product being greater than 2.2. The product mentioned has also proven to be particularly advantageous when a corresponding electric motor is used in a battery-powered power tool, the energy supply device of the power tool preferably being designed to deliver large constant currents, for example in a range of more than 50 amperes (A), preferably more than 70 A and most preferably of more than 100 A. Surprisingly, the electric motor can also be cooled particularly well and efficiently, especially in such applications. In addition, tests have shown that an electric motor with the product mentioned has a particularly high degree of efficiency because any empty spaces within the stator of the electric motor are particularly well filled with electromagnetically active material or have a high degree of filling. As a result, the electric motor can be operated optimally and particularly efficiently from both ecological and economic aspects.

It is preferred in the sense of the invention that the total of the total winding conductor cross sections is the total of the non-insulated total winding conductor cross sections. This preferably means in the sense of the invention that only those contributions of a single conductor to the total winding conductor cross section that are electromagnetically effective, for example by going back to the electrically conductive material in a single conductor, are taken into account. Insulation and insulating material, which is often made of plastic, preferably make no electromagnetic contribution to the generation of a rotational movement in the electric motor, so that, in the context of this configuration of the invention, the sum of the non-insulated total winding conductor cross sections is preferably used and set in relation to a free winding cross section of the stator.

It is preferred in the sense of the invention that the product is greater than 2.5, preferably greater than 2.8. The drive and heat dissipation efficiency of the electric motor can be further increased by the values mentioned.

The inventors have recognized that it is desirable if the degree of filling of the grooves of the stator is as high as possible or if the empty spaces within the stator are as small as possible. This basic idea is achieved with the electric motors. In particular, with the invention a minimization of the empty volume within the stator can be achieved in order to allow a power-optimized electromagnetic configuration of the stator topology.

It is preferred in the sense of the invention that the number of pole teeth is in a range of two to twelve, preferably four to ten, particularly preferably between six and eight. On the one hand, a stator with the specified number of pole teeth can be produced and wound in a particularly simple manner, on the other hand, a high degree of efficiency and good heat dissipation from the stator can be ensured as a result. It is preferred in the sense of the invention that a number of grooves is also in a range of two to twelve, preferably four to ten, particularly preferably between six and eight. It is preferred in the sense of the invention that the electric motor is an internal rotor motor.

It is preferred in the sense of the invention that the electric motor is segmented, a number of segments of the electric motor being in a range of two to twelve, preferably four to ten, particularly preferably between six and eight. The segmentation of the electric motor can in particular simplify the production of the winding. It is preferred in the sense of the invention that the metal wire from which the coils are wound can run within the grooves and be present wound around the pole teeth. The grooves may have slits through which the wire can be inserted into the groove during the winding process. The slits may be in the direction of the inner bore of the stator and connect the interior space of the stator, which is preferably formed by the inner bore for receiving the rotor, to the groove itself. Consequently, the slits establish a connection between the interior space of the stator and the grooves. The pole teeth of the stator of the electric motor may be aligned radially inward, that is to say in the direction of the rotor or the stator bore. However, it may also be preferred in the sense of the invention that the pole teeth of the stator are directed outward, so that the rotor can be wound from the outside.

It is preferred in the sense of the invention that conductors which fill the grooves or the empty volumes (or in a plan view: the empty areas) of the stator particularly well in their entirety are used to produce the winding. For example, conductors with such cross sections that are particularly well suited for filling a predetermined area, such as the sectional area through a groove of the stator, particularly efficiently may be used. The aim here is a tiling of the groove surfaces that is as seamless as possible, such as with a Penrose pattern. For example, conductors with rectangular or square cross sections can be used because they can be lined up particularly well and with little offset in a preferably two-dimensional area. Also conceivable are honeycomb or hexagonal, as well as other multi-cornered, polygonal cross sections or conductors with such cross sections in order to achieve a particularly high degree of filling of the grooves and/or empty areas with electromagnetically active material, in particular the conductor or wire material.

The electric motors each have a particularly high degree of groove filling, that is to say the grooves within the stator are filled particularly efficiently with electromagnetically active material. The filling preferably takes place by the windings with which coils are produced, the windings preferably comprising at least one conductor (“single winding”). The windings may however also comprise a plurality of conductors (“multiple winding”). It has been found that high degrees of groove filling, as are made possible in the context of the invention, lead to improved ventilation of the electric motor. This means that enclosed ventilation can be improved if the grooves in the stator of the electric motor are better filled with winding material. In addition, external ventilation can also be improved if there is a high degree of groove filling. With both cooling methods, the amount of air that is brought into the immediate vicinity of the winding or the winding material can be significantly reduced by the invention, so that in particular also less dirt or dust gets into the area of the winding. This can effectively prevent clogging of the empty spaces in the grooves between the winding conductors.

In a second aspect, the invention relates to a power tool with one of the electric motors. It is preferred in the sense of the invention that the power tool is detachably connected to an energy supply device, the energy supply device being designed to supply the power tool with electrical energy.

In a further aspect, the invention relates to a system comprising a power tool according to the invention and an energy supply device, the energy supply device comprising at least one energy storage cell (“cell”), the at least one energy storage cell having an internal resistance DCR_I of less than 10 milliohms. The terms, definitions and technical advantages introduced for the electric motors preferably apply analogously to the power tool and the system.

In preferred configurations of the invention, the internal resistance DCR_I of the at least one cell may be less than 8 milliohms and preferably less than 6 milliohms. Here, the internal resistance DCR_I is preferably measured in accordance with the standard IEC61960. The internal resistance DCR_I represents in particular the resistance of a cell of the energy supply device, any components or accessories of the cell making no contribution to the internal resistance DCR_I. A low internal resistance DCR_I is advantageous, since this means that unwanted heat that has to be removed does not occur at all. The internal resistance DCR_I is in particular a DC resistance which can be measured in the interior of a cell of the energy supply device. The internal resistance DCR_I may of course also assume intermediate values such as 6.02 milliohms; 7.49 milliohms; 8.33 milliohms; 8.65 milliohms or 9.5 milliohms.

It has been found that, with the internal resistance DCR_I of the at least one cell of less than 10 milliohms, an energy supply device which has particularly good thermal properties in the sense that it can be operated particularly well at low temperatures can be provided, while the cooling expenditure can be kept surprisingly low. In particular, an energy supply device with an internal cell resistance DCR_I of less than 10 milliohms is particularly well suited for supplying particularly powerful power tools with electrical energy. The energy supply device can therefore make a valuable contribution to allowing use of rechargeable battery-operated power tools even in areas of application that those skilled in the art previously assumed were not accessible by rechargeable battery-operated power tools.

Advantageously, such an energy supply device can be used to provide a possibility of supplying a battery-operated or rechargeable battery-operated power tool by an energy supply device according to the invention with a high output power over a long period of time without harming the surrounding plastic components or the cell chemistry within the cells of the energy supply device.

The energy supply device is preferably an energy supply device with a particularly long service life and/or an energy supply device which is designed to deliver particularly high currents, in particular constant currents of more than 50 amperes, preferably more than 70 amperes and most preferably of more than 100 amperes. The particularly long service life can preferably result in the energy supply device surviving a particularly large number of insertion processes or insertion cycles without wearing out. In addition, the particularly long service life can mean that the chemical components of the energy supply device are designed to be able to be charged more frequently than previous energy supply devices without significantly aging.

An essential advantage of the invention is that the electric motors have a high degree of useful filling, which makes it possible to deal well with high constant output currents in ranges of more than 50 amperes, preferably more than 70 amperes and most preferably of more than 100 amperes and to convert these high currents optimally into a rotational movement to drive the power tool. As a result, the advantages of new cell and battery technologies can be optimally utilized with the aid of the invention. Consequently, with the invention, an efficient use of energy supply devices in battery-operated power tools can be made possible, in particular also for applications and uses that demand very high electrical power requirements of the system.

It is preferred in the sense of the invention that a ratio of a resistance of the at least one cell to a surface A of the at least one cell is less than 0.2 milliohms/cm², preferably less than 0.1 milliohms/cm² and most preferably less than 0.05 milliohms/cm². In the case of a cylindrical cell, the surface of the cell may be formed for example by the outer surface of the cylinder as well as the top side and the bottom side of the cell. Furthermore, it may be preferred in the sense of the invention that a ratio of a resistance of the at least one cell to a volume V of the at least one cell is less than 0.4 milliohms/cm³, preferably less than 0.3 milliohms/cm³ and most preferably less than 0.2 milliohms/cm³. For conventional geometrical shapes, such as cuboids, cubes, spheres or the like, a person skilled in the art knows the formulae for calculating the surface or the volume of such a geometrical body. In the sense of the invention, the term “resistance” preferably denotes the internal resistance DCR_I, which can preferably be measured in accordance with the standard IEC61960. This is preferably a DC resistor.

It is preferred in the sense of the invention that the term “surface” is understood as meaning a maximum, enveloping casing surface of an object. In the context of the present invention, this may mean in particular that the surface of a body or an object is interpreted as the sum of its boundary surfaces. the term “volume” is preferably understood In the sense of the invention as meaning that space which is enclosed by the maximum, enveloping casing surface of the object.

It is preferred in the sense of the invention that the at least one cell has a heating coefficient of less than 1.0 W/(Ah·A), preferably less than 0.75 W/(Ah·A) and particularly preferably of less than 0.5 W/(Ah·A). Furthermore, the at least one cell may be designed to deliver a current of greater than 1000 amperes/liter substantially constantly. The discharge current is indicated with reference to the volume of the at least one cell, the spatial unit of measure “liter” (I) being used as the unit for the volume. The cells according to the invention are therefore able to deliver a discharge current of substantially constantly greater than 1000 A per liter of cell volume. In other words, a cell with a volume of 1 liter is able to deliver a substantially constant discharge current of greater than 1000 A, while the at least one cell also has a heating coefficient of less than 1.0 W/(Ah·A). In preferred configurations of the invention, the at least one cell of the energy supply device may have a heating coefficient of less than 0.75 W/(Ah·A), preferably less than 0.5 W/(Ah·A). The unit for the heating coefficient is watts/(ampere hours·amperes). The heating coefficient can of course also have intermediate values, such as 0.56 W/(Ah·A); 0.723 W/(Ah·A) or 0.925 W/(Ah·A).

The invention advantageously allows the provision of an energy supply device having at least one energy storage cell which has reduced heating and therefore is particularly well suited for supplying power tools in which high power outputs and high currents, preferably constant currents, are desired for operation. In particular, the invention can be used to provide an energy supply device for a power tool in which the heat which possibly occurs during operation of the power tool and when delivering electrical energy to the power tool can be dissipated in a particularly simple and uncomplicated manner. Tests have shown that the invention can not only be used to more effectively dissipate existing heat. Rather, the invention prevents heat from being generated or with the invention the quantity of heat generated during operation of the power tool can be reduced considerably. The invention can advantageously be used to provide an energy supply device which can supply electrical energy optimally, especially also to power tools which demand high requirements in respect of power and discharge current. In other words, the invention can provide an energy supply device for particularly powerful power tools with which for example heavy drilling or demolition work can be performed on construction sites.

The term “power tool” should be understood in the sense of the invention as meaning a typical piece of equipment that can be used on a construction site, for example a building construction site and/or a civil engineering construction site. It may be hammer drills, chisels, core drills, angle or cut-off grinders, cutting devices or the like, without being restricted thereto. In addition, auxiliary devices such as those occasionally used on construction sites, such as lamps, radios, vacuum cleaners, measuring devices, construction robots, wheelbarrows, transport devices, feed devices or other auxiliary devices can be “power tools” in the sense of the invention. The power tool may be in particular a mobile power tool, though the energy supply device can also be used in particular in stationary machine tools, such as column-guided drills or circular saws. However, preference is given to hand-held power tools that are in particular rechargeable battery-operated or battery-operated.

It is preferred in the sense of the invention that the at least one cell has a temperature cooling half-life of less than 12 minutes, preferably less than 10 minutes, particularly preferably less than 8 minutes. This preferably means in the sense of the invention that, with free convection, a temperature of the at least one cell is halved in less than 12, 10 or 8 minutes. The temperature cooling half-life is preferably determined in an inoperative state of the energy supply device, that is to say when the energy supply device is not in operation, that is to say is present in a manner connected to a power tool. Energy supply devices with temperature cooling half-lives of less than 8 mins have especially been found to be particularly suitable for use in powerful power tools. The temperature cooling half-life may of course also have a value of 8.5 minutes, 9 minutes 20 seconds or of 11 minutes 47 seconds.

Due to the surprisingly low temperature cooling half-life of the energy supply device, the heat generated during operation of the power tool or when it is charging only remains within the at least one cell for a short time. In this way, the cell can be recharged particularly quickly and is rapidly available for re-use in the power tool. Moreover, the thermal loading on the component of the energy supply device or the power tool having the energy supply device can be considerably reduced. As a result, the energy supply device can be preserved and its service life extended.

It is preferred in the sense of the invention that the at least one cell is arranged in a battery pack of the energy supply device. A series of single cells can preferably be combined in the battery pack and in this way optimally inserted into the energy supply device. For example, 5, 6 or 10 cells may form a battery pack, integer multiples of these numbers also being possible. For example, the energy supply device may have individual cell strings, which may for example comprise 5, 6 or 10 cells. An energy supply device with for example three strands of five cells each may for example comprise 15 single cells.

It is preferred in the sense of the invention that the energy supply device has a capacity of at least 2.2 Ah, preferably at least 2.5 Ah. Tests have shown that the capacitance values mentioned are particularly well suited for the use of powerful power tools in the construction industry and correspond particularly well to the requirements there for the availability of electrical energy and the possible service life of the power tool.

The at least one cell of the energy supply device is preferably designed to deliver a discharge current of at least 20 A over at least 10 s. For example, a cell of the energy supply device may be designed to provide a discharge current of at least 20 A, in particular at least 25 A, over at least 10 s. In other words, the at least one cell of an energy supply device may be designed to provide a continuous current of at least 20 A, in particular of at least 25 A.

It is also conceivable that peak currents, in particular short-term peak currents, can lead to strong heating of the energy supply device. Therefore, an energy supply device with powerful cooling, as can be achieved by the measures described here, is particularly advantageous. It is conceivable for example that at least one cell of the energy supply device can provide at least 50 A over 1 second. In other words, it is preferred in the sense of the invention that the at least one cell of the energy supply device is designed to provide a discharge current of at least 50 A over at least 1 s. Power tools can often require high power outputs for a short period of time. An energy supply device of which the cells are capable of delivering such a peak current and/or such a continuous current may therefore be particularly suitable for powerful power tools such as those used on construction sites.

It is preferred in the sense of the invention that the at least one cell comprises an electrolyte, the electrolyte preferably being in a liquid state of aggregation at room temperature. The electrolyte may comprise lithium, sodium and/or magnesium, without being restricted thereto. In particular, the electrolyte may be lithium-based. As an alternative or in addition, it may also be sodium-based. It is also conceivable that the rechargeable battery is magnesium-based. The electrolyte-based energy supply device may have a nominal voltage of at least 10 volts (V), preferably at least 18 V, in particular of at least 28 V, for example 36 V. A nominal voltage in a range of 18 to 22 V, in particular in a range of 21 to 22 V, is most particularly preferred. It is most particularly preferred in the sense of the invention that a nominal voltage of energy supply device is in a range of 12 to 50 V. The at least one cell of the energy supply device may for example have a voltage of 3.6 V, without being restricted thereto.

It is preferred in the sense of the invention that the energy supply device is charged for example at a charging rate of 1.5 C, preferably 2 C, and most preferably 3 C. A charging rate×C can be understood as meaning the current intensity that is required to fully charge a discharged energy supply device fully in a fraction of an hour corresponding to the numerical value x of the charging rate×C. For example, a charging rate of 3 C enables the rechargeable battery to be fully charged within 20 minutes.

It is preferred in the sense of the invention that the at least one cell of the energy supply device has a surface A and a volume V, a ratio A/V of the surface to the volume being greater than six times, preferably eight times and more preferably ten times, the reciprocal of the cube root of the volume.

The expression that the surface A of the at least one cell is greater than for example eight times the cube root of the square of the volume V can preferably also be expressed by the formula A>8*V\hat{ }(⅔). Written another way, this relationship can be described by the ratio A/V of surface to volume being greater than eight times the reciprocal of the cube root of the volume.

To check whether the above relationship is satisfied, values in the same basic unit must always be used. If for example a value for the surface in m² is entered in the above formula, a value in the unit m³ is preferably used for the volume. If for example a value for the surface in the unit cm² is entered in the above formula, a value in the unit cm³ is preferably used for the volume. I for example a value for the surface in the unit mm² is entered in the above formula, a value in the unit mm³ is preferably used for the volume.

Cell geometries which for example satisfy the relationship of A>8*V\hat{ }(⅔) advantageously have a particularly favorable ratio between the outer surface of the cell, which is critical for the cooling effect, and the cell volume. The inventors have recognized that the ratio of surface to volume of the at least one cell of the energy supply device has an important influence on the heat dissipation from the energy supply device. The improved cooling capacity of the energy supply device can advantageously be achieved by increasing the cell surface given a constant volume and a low internal resistance of the at least one energy storage cell. It is preferred in the sense of the invention that a low cell temperature with at the same time a high power output can preferably be made possible if the internal resistance of the cell is reduced. Reducing the internal resistance of the at least one cell can result in less heat being generated. In addition, a low cell temperature can be achieved by using cells in which the surface A of at least one cell within the energy supply device is greater than six times, preferably eight times and particularly preferably ten times the cube root of the square of the volume V of the at least one cell. As a result, in particular the heat dissipation to the environment can be improved.

It has been found that energy supply devices of which the cells satisfy the stated relationship can be cooled significantly better than previously known energy supply devices with for example cylinder-shaped cells. The above relationship can be satisfied for example by the cells of the energy supply device having a cylinder-shaped basic shape, but additional surface-increasing elements being arranged on its surface. These may be for example ribs, teeth or the like. Cells which do not have a cylinder-shaped or cylindrical basic shape, but rather are shaped entirely differently, may also be used within the scope of the invention. For example, the cells of the energy supply device may have a substantially cuboidal or cube-shaped basic shape. The term “substantially” is unclear here to a person skilled in the art because a person skilled in the art knows that, in the context of the present invention, for example a cuboid with indentations or rounded corners and/or edges should also be covered by the term “substantially cuboidal”

It is preferred in the sense of the invention that the at least one cell has a cell nucleus, while no point within the cell nucleus is more than 5 mm away from a surface of the energy supply device. When the energy supply device is discharged, for example when it is connected to a power tool and work is performed with the power tool, heat can be produced in the cell nucleus. In this specific configuration of the invention, this heat can be transported to the surface of the cell of the energy supply device on a comparatively short path. The heat can be optimally dissipated from the surface. Therefore, such an energy supply device can have good cooling, in particular comparatively good self-cooling. The time period until the limit temperature is reached can be extended and/or reaching the limit temperature can advantageously be avoided entirely. As a further advantage of the invention, a relatively homogeneous temperature distribution can be achieved within the cell nucleus. This can result in uniform aging of the rechargeable battery. This can in turn increase the service life of the energy supply device.

It is preferred in the sense of the invention that the term “cell nucleus” is understood as the focal point of an object, here preferably the battery cell. In a preferred configuration of the invention, a shortest distance between the enveloping area of the battery cell and the center of gravity is therefore preferably a maximum of 5 mm. In other words, in a preferred embodiment of the invention, the cell nucleus and the casing or surface of the battery cell are no further apart than 5 mm.

It is preferred in the sense of the invention that the at least one cell has a maximum constant current output of greater than 20 amperes, preferably greater than 30 amperes, most preferably greater than 40 amperes. The maximum constant current output is the quantity of current of a cell or an energy supply device that can be drawn without the cell or the energy supply device reaching an upper temperature limit. Possible upper temperature limit may lie in a region of 60° C. or 70° C., without being restricted thereto. The unit for the maximum constant current output is amperes.

All intermediate values should also always be considered to be disclosed in the case of all the value ranges that are mentioned in the context of the present invention. For example, values of between 20 and 30 A, that is to say 21, 22.3, 24, 25.55 or 27.06 amperes for example, should also be considered to be disclosed in the case of the maximum constant current output. Furthermore, values of between 30 and 40 A, that is to say 32, 33.3, 36, 38.55 or 39.07 amperes for example, should also be considered to be disclosed.

It is preferred in the sense of the invention that the energy supply device has a discharge C rate of greater than 80·t\hat{ }(−0.45), where the letter “t” stands for time in the unit seconds. The C rate advantageously allows quantification of the charging and discharge currents for energy supply devices, the discharge C rate used here allowing in particular the quantification of the discharge currents of energy supply devices. For example, the maximum permissible charging and discharge currents can be indicated by the C rate. These charging and discharge currents preferably depend on the rated capacity of the energy supply device. The unusually high discharge C rate of 80·t\hat{ }(0.45) advantageously means that the energy supply device can be used to achieve particularly high discharge currents which are required for operating powerful power tools in the construction industry. For example, the discharge currents may lie in a region of greater than 40 amperes, preferably greater than 60 amperes or even more preferably greater than 80 amperes.

It is preferred in the sense of the invention that the cell has a cell temperature gradient of less than 10 Kelvin. The cell temperature is preferably a measure of the temperature differences within the at least cell of the energy supply device, it being preferred in the sense of the invention that the cell has a temperature distribution that is as uniform as possible, that is to say that a temperature in an inner region of the cell differs as little as possible from a temperature which is measured in the region of a casing or outer surface of the cell.

The electric motor of the power tool has a stator with an inner opening for receiving a rotor. The inner opening has a diameter which corresponds to an inner stator diameter, the stator having a series of pole teeth, which are each wound with a winding to form a coil. The winding is characterized by a reference diameter, it being particularly preferred in the sense of the invention that a ratio of the reference diameter of the winding to the inner stator diameter multiplied by a number of pole teeth and the reciprocal value of the internal resistance DCR_I of an energy storage cell of the energy supply unit is greater than 0.03 (milliohms)⁻¹ The internal resistance DCR_I of the energy storage cell is preferably given in milliohms. This ratio can be represented using the following formula:

$$\frac{D\_Ref}{D\_Stator} * n * \frac{1}{DCR\_I} > 0.03 \frac{1}{mOhm} ,$$

where D_Ref stands for the reference diameter of the winding, D_Stator for the diameter of the inner opening of the stator, n for the number of pole teeth and DCR_I for the internal resistance DCR_I of the energy storage cell.

It is also particularly preferred in the sense of the invention that a ratio is formed from a sum of the total winding conductor cross sections and a free winding cross section, the ratio being multiplied by a number of pole teeth and the reciprocal value of the internal resistance DCR_I in milliohms of an energy storage cell of the energy supply unit, the product being greater than 0.22 (milliohms)⁻¹. The internal resistance DCR_I of the energy storage cell is preferably given in milliohms. This ratio can be represented using the following formula:

$$\frac{A\_Wl \_ges}{A\_free winding cross section} * n * \frac{1}{DCR\_I} > 0.22 \frac{1}{mOhm}$$

where A_WI_ges stands for the sum of the total winding conductor cross sections, A_free winding cross section for the sum of the free winding cross sections, n for the number of pole teeth and DCR_I for the internal resistance DCR_I of the energy storage cell.

In most particularly preferred configurations of the invention, the above ratio is greater than 0.25 (milliohms)⁻¹ or greater than 0.28 (milliohms)⁻¹.

It has been found that power tools with motors and energy supply devices of which the properties are matched to one another as described above are particularly powerful and robust. They are particularly well suited to ensure that the performance of future battery technologies can be optimally used, especially under rough construction site conditions with strong vibrations and dust entering the device.

The ratios of the diameters or winding cross-sectional areas mentioned above, which are preferably greater than 0.03 (milliohms)⁻¹ or greater than 0.22 (milliohms)⁻¹ are obtained from the conditions according to the invention, as well as the internal resistance DCR_I of an energy storage cell of a maximum of 10 milliohms mentioned above, the internal resistance DCR_I preferably being measured according to the IEC61960 standard. The above definitions, technical effects and advantages apply analogously. In the following formula, the value of 10 milliohms as the internal resistance DCR_I is substituted into the above formula for the diameter ratio. This gives the preferred value of “>0.03 (milliohms)⁻¹” for the diameter ratio:

$$\frac{D\_Ref}{D\_Stator} * n * \frac{1}{10 mOhm} > 0.03 * \frac{1}{10 mOhm}$$

The internal resistance DCR_I preferably represents the resistance of an energy storage cell of the energy supply device, any components or accessories of the cell making no contribution to the internal resistance DCR_I. A low internal resistance DCR_I is advantageous, since this means that unwanted heat that has to be removed does not occur at all. The internal resistance DCR_I is in particular a DC resistance which can be measured in the interior of a cell of the energy supply device.

It has been found that with the internal resistance DCR_I of the at least one energy storage cell of the energy supply device of less than 10 milliohms in combination with the motor properties mentioned, a power tool can be provided which has particularly good thermal properties in the sense that it is particularly good at can be operated at low temperatures, and the cooling effort can be kept surprisingly low. In particular, a particularly powerful power tool can be supplied with electrical energy using the invention. Such power tools with the coordinated motor and battery properties can make a valuable contribution to enabling the use of battery-operated power tools in areas of application where experts had previously assumed that these areas of application were not accessible to battery-operated power tools.

Advantageously, the invention can be used to provide a power tool that can be supplied with a high power output over a long period of time without damaging plastic components or the cell chemistry of the energy supply device.

An essential advantage of the invention is that the electric motors have a high degree of filling, which makes it possible to deal well with high constant output currents in ranges of more than 50 amperes, preferably more than 70 amperes and most preferably more than 100 amperes optimally convert these high currents into a rotational movement to drive the power tool. As a result, the advantages of new cell and battery technologies can be optimally utilized with the aid of the invention. Consequently, with the invention, an efficient use of energy supply devices in battery-operated power tools can be made possible, in particular for applications and uses that place very high electrical power requirements on the system.

It has also been shown that the combination of electric motor and energy supply device can be used particularly well in systems in which the energy supply device is regularly removed from the power tool, for example to be charged. The electrical properties of the energy supply device, in particular the feature according to which the internal resistance DCR_I of the at least one energy storage cell of the energy supply device is less than 10 milliohms, can advantageously mean that a large number of removal and insertion cycles can be carried out without aging of the energy supply device occurs.

Thus, in the context of the present invention, an electric motor, a power tool, and a system including a power tool and an energy supply device are disclosed. The power tool has a electric motor in which a ratio of the reference diameter of the winding to the inner stator diameter multiplied by a number of pole teeth and the reciprocal value of the internal resistance DCR_I of an energy storage cell of the energy supply unit is greater than 0.03 (milliohms)⁻¹ is. Alternatively, in the electric motor of the power tool, a ratio can be formed from a sum of the total winding conductor cross sections and a free winding cross section, the ratio being multiplied by a number of pole teeth and the reciprocal value of the internal resistance DCR_I in milliohms of an energy storage cell of the energy supply unit, the product being greater than 0.22 (milliohms)⁻¹. The system comprises a power tool with such an electric motor and an energy supply device with at least one energy storage cell with an internal resistance DCR_I of a maximum of 10 milliohms. The electric motor, the power tool, the system and the energy supply device represent different aspects of the present invention.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

Identical and similar components are denoted by the same reference signs in the figures, in which:

FIG. 1 shows a schematic sectional drawing through a preferred configuration of the stator of the electric motor

FIG. 2 shows a further schematic sectional drawing through a preferred configuration of the stator of the electric motor

FIG. 3 shows a schematic sectional drawing through a preferred configuration of a single segment of the stator of the electric motor

FIG. 4 shows a schematic representation of a total winding conductor cross section and a reference diameter or an equivalent winding conductor diameter

FIG. 5 shows a schematic representation of the stator with sums of the total winding conductor cross sections

FIG. 6 shows a schematic representation of different stators

FIG. 7 shows a schematic side view of a preferred configuration of the energy supply device

FIG. 8 shows a schematic side view of a power tool with a preferred configuration of the energy supply device

FIGS. 9a and 9b show a schematic view of a possible configuration of a segment of the stator.

### DETAILED DESCRIPTION

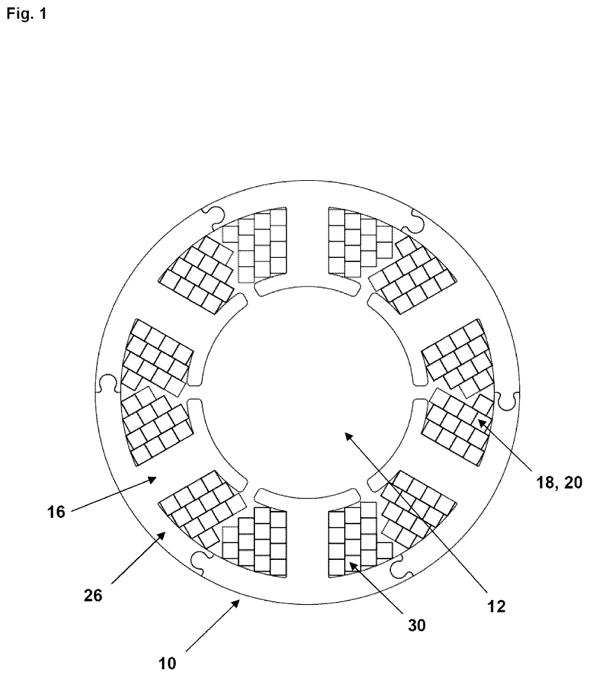

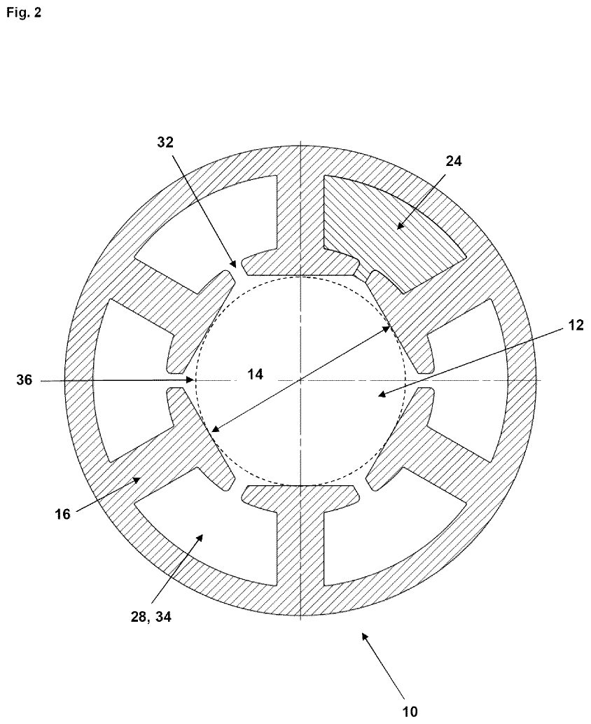

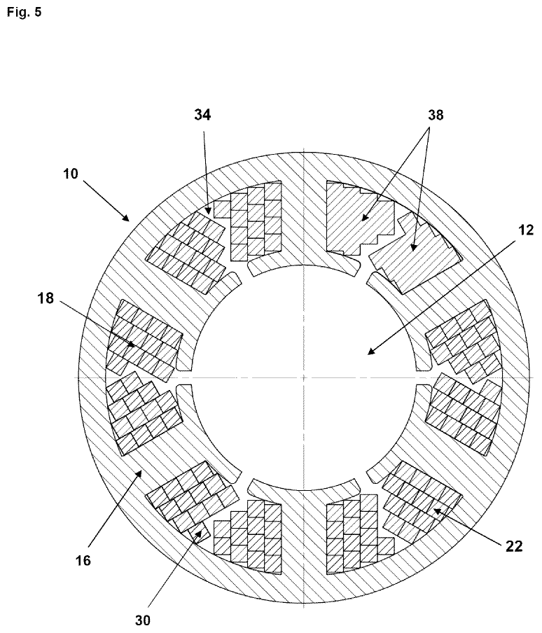

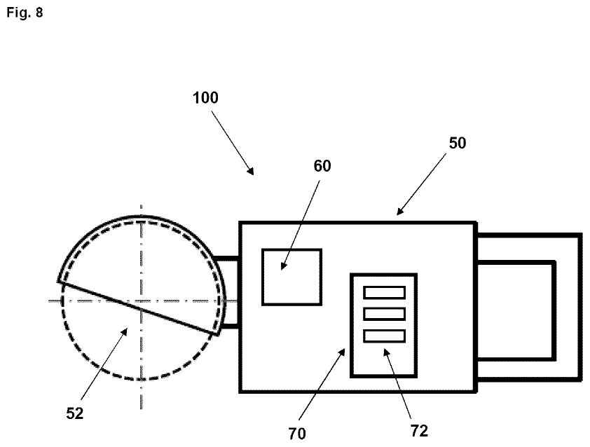

FIG. 1 shows a schematic sectional drawing through a preferred configuration of the stator 10 of the electric motor 60 (see FIG. 8). In particular, FIG. 1 shows a sectional representation in a plane of which the surface normal corresponds to the axis of rotation of the electric motor 60. The axis of rotation of the electric motor 60 is preferably arranged substantially perpendicular to the plane of the figure or paper, that is to say the axis of rotation of the electric motor 60 comes out of the plane of the drawing and toward the viewer. The stator 10 shown in FIG. 1 has grooves 28 (see FIG. 2) and pole teeth 16, which are preferably arranged next to one another. The grooves 28 represent free spaces within the otherwise preferably solidly constructed stator 10, these free spaces being used to wind a metal, winding or conductor material around the pole teeth 16. Metal wires may represent single conductors 22 (see, e.g, FIG. 5) and be used to wind around the pole teeth 16 of the stator 10, so that windings 18 which form coils 20 for generating magnetic fields are obtained. The electric motor 60 may preferably be used in a power tool 50 in order to drive a tool 52 of the power tool 50. The power tool 50 may be a rechargeable battery-operated power tool 50, which preferably has an energy supply device 70 (see, e.g, FIG. 8).

The stator 10 has in its interior an inner opening 12, in which a rotor can rotate. The inner opening 12 may also be referred to as a stator bore, the inner opening 12 having a diameter 14 (see, e.g, FIG. 2). This diameter 14 is referred to in the sense of the invention as the stator inner diameter 14. The stator inner diameter 14 preferably corresponds to the diameter of an inscribed circle 36 (see FIG. 2) which can be placed in the inner opening 12 of the stator 10. The pole teeth 16 may be aligned in the direction of the inner opening 12 of the stator 10. Slits 32, which form a connection between the inner opening 12 and the grooves 28, may be provided. These slits 32 are intended for inserting or passing through the metal wires in the production of the winding 18 of the coils 20. The cross sections 30 of single conductors 22 can be seen within the grooves 28 in FIG. 1. The cross sections may be substantially circular or have a rectangular or square base area, as in the example in FIG. 1. For example, the cross sections 30 of the conductors 22 forming the windings 18 may be formed as honeycombed, hexagonal, triangular, elliptical or pentagonal, without being restricted thereto. The selection of suitable cross sections 30 of the conductors 22 preferably leads to a particularly high degree of filling of the grooves 28 with an electromagnetically active metal, winding or conductor material, so that the invention can be used to provide an electric motor which is particularly powerful, can be efficiently operated and can be cooled well.

The stator 10 may be segmented, that is to say composed of a number of single segments 26. In the exemplary embodiment of the invention shown in FIG. 1, the stator 10 has for example six segments 26. The segmentation of the stator 10 facilitates the winding process by which the windings 18 are produced.

FIG. 2 shows a further schematic sectional drawing through a preferred configuration of the stator 10 of the electric motor 60. Shown is the inner opening 12 of the stator 10 and a so-called inscribed circle 36, which can be used for determining the diameter 14 of the inner opening 12 of the stator 10. The stator 10 shown in FIG. 2 has six pole teeth 16 and six winding windows 34 or grooves 28. The winding windows 34 or grooves 28 may be connected to the inner opening 12 of the stator 10 via slits 32. In addition, the so-called free winding cross section 24 is shown in FIG. 2. The free winding cross section 24 may preferably correspond to that area which is available per winding 18 or per pole tooth 16 for the winding 18 or for receiving the conductive winding material to form a coil 20. If the stator 10 comprises for example six pole teeth 16, the stator 10 preferably also has six free winding cross sections 24, which are preferably also referred to in the sense of the invention as grooves 28. The grooves 28 or free winding cross sections 24 are preferably arranged between two pole teeth 16 each, approximately one half of a free winding cross section 24 being available for the winding 18 around the one adjacent pole tooth 16 and the other half for the winding 18 around the other adjacent pole tooth 16.

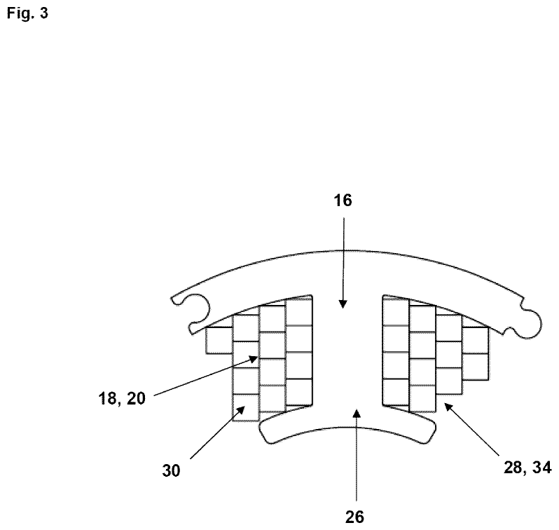

FIG. 3 shows a schematic sectional drawing through a preferred configuration of a single segment 26 of the stator 10 of the electric motor 60. The single segment 26 has a pole tooth 16, the pole tooth 16 being surrounded by a winding 18. In other words, at least one conductor 22 is wound around the pole tooth 16 to produce a coil 20 for generating magnetic fields. The material that makes up the winding 18 is preferably present in the grooves 28 of the stator 10. The cross sections 30 of the conductors 22 from which the winding 18 is produced in the example of the invention shown in FIG. 3 have a rectangular base area, so that the groove 28 or the winding window 34 can be tiled or filled particularly fully or without gaps over its surface area.

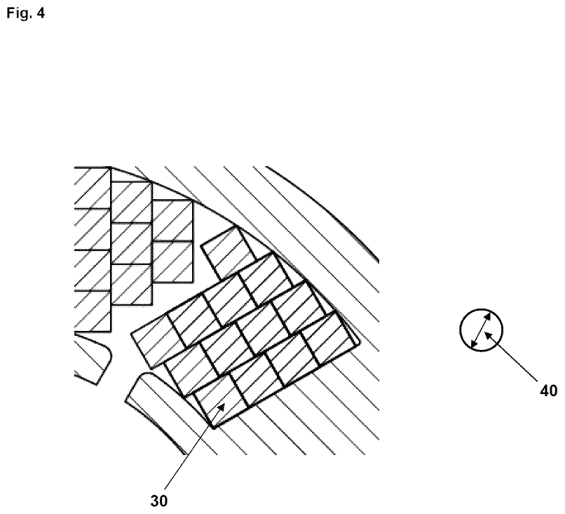

FIG. 4 shows a schematic representation of a total winding conductor cross section 30 and a reference diameter 40 or an equivalent winding conductor diameter 40. The total winding conductor cross section 30 can be converted into the equivalent winding conductor diameter 40 using the formula given in the description.

FIG. 5 shows a schematic representation of the stator 10 with sums 38 of total winding conductor cross sections 30. Individual conductors 22 can run in the free winding cross sections 24 (not shown in FIG. 5) in order to form a winding 18 and a coil. The conductors 22 shown in FIG. 5 have square or rectangular total winding conductor cross sections 30. Since the conductor 22 is wound multiple times around the pole tooth 16, in the sectional representation shown in FIG. 5, the surface normal of which corresponds to an axis of rotation of the electric motor 60, a plurality of small squares are shown, intended each to symbolize a total winding conductor cross section 30. The winding windows 34 are each delimited by two pole teeth 16, so that the “half” windings 18 of two pole teeth 16 are contained in each winding window 34. This “half” winding 18 is shown in FIG. 5 as one of two partial areas of the sum 38 of the total winding conductor cross sections 30. The sum 38 of the total winding conductor cross sections 30 preferably represents the sum of the two partial areas shown in FIG. 5 and provided with the reference number 38. The sum 38 of the total winding conductor cross sections 30 preferably corresponds to the area occupied by the winding material, that is to say the conductors 22 forming the winding 18, in the sectional representation. It is preferred in the sense of the invention that the term “sum 38 of the total winding conductor cross sections 30” is with reference to a winding window 34, so that the sum of the two partial areas provided with reference number 38 is formed in order to obtain the “sum 38 of the total winding conductor cross sections 30”.

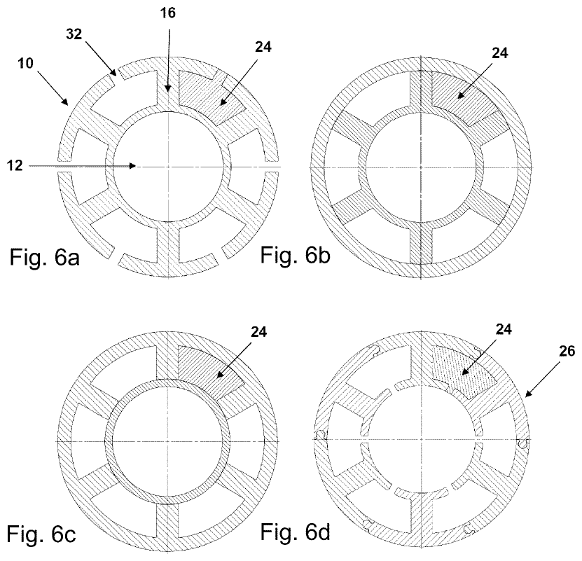

FIG. 6 shows a schematic representation of various stators 10 that can be used in the electric motors 60. The stators 10 shown in the Subfigures a-d each have pole teeth 16 and inner openings 12. Slits 32 and the free winding cross sections 24 of the stators 10 are also shown in each case. Subfigure a shows an externally grooved six-pole stator 10, that is to say a stator 10 with six pole teeth 16. Subfigure b also shows a six-pole stator 10 which is formed as two parts and is separated on the outside, while Subfigure c shows a six-pole stator 10 which is separated on the inside and is also formed as two parts. Subfigure d shows a segmented six-pole stator 10, that is to say a stator 10 which has six pole teeth 16 and which can also be composed of individual segments 26.

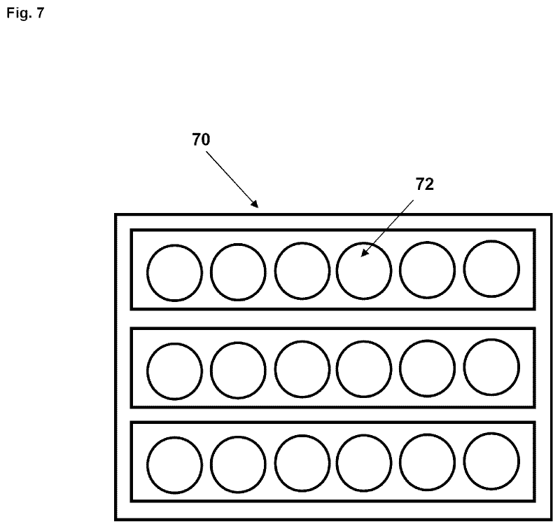

FIG. 7 shows a schematic side view of a preferred configuration of the energy supply device 70. The energy supply device 70 shown in FIG. 7 has eighteen energy storage cells 72, the eighteen cells 72 being arranged in three strands within the energy supply device 70. The cells 72 are symbolized in particular by the circles, while the strands are symbolized by the elongated rectangles surrounding the circles (“cells 72”).

FIG. 8 shows a schematic view of a power tool 50 with a energy supply device 70. The power tool 50 may be for example a cut-off grinder, which has a cut-off wheel as the tool 52. The power tool 50 may have a handle, which is for example formed as a rear handle. In addition, the power tool 50 may have operator control elements, such as switches or buttons, in a manner known per se. In addition, the power tool 50 may have an electric motor 60 according to the invention, which can represent a consumer and be supplied with electrical energy by the energy supply device 70.

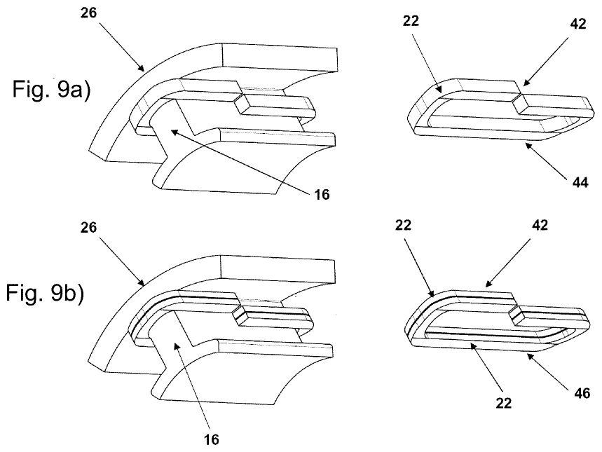

FIGS. 9a and 9b show a schematic view of a possible configuration of a segment 26 of the stator 10. In particular, FIGS. 9a and 9b are intended to show the difference between a single winding (reference number 44, FIG. 9a) and a multiple winding (reference number 46, FIG. 9b). Single windings 44 preferably comprise one conductor 22, while multiple windings 46 comprise at least two conductors 22. The conductor or conductors 22 can be wound around a pole tooth 16 of the stator in order to obtain a winding 18. It is preferred in the sense of the invention that a turn 42 is formed by the wire, that is to say a conductor 22, being led once around a bobbin, that is to say the pole tooth 16. The entirety of the turns 42 is referred to as the winding 18. Just one turn 42 is shown in FIGS. 9a and 9b, so that this is not yet referred to as a winding 18. The turn 42 shown in FIG. 9b is formed by two conductors 22. It may be preferred in the sense of the invention that the stator 10 comprises single windings 44 and/or multiple windings 46.

### LIST OF REFERENCE SIGNS

10 Stator
12 Inner opening of the stator
14 Stator inner diameter
16 Pole tooth of the stator
18 Winding
20 Coil
22 Single conductor
24 Free winding cross section
26 Segment of the stator
28 Groove
30 Total winding conductor cross section
32 Slit
34 Winding window
36 Inscribed circle
38 Sum of the total winding conductor cross sections
40 Reference diameter, equivalent winding conductor diameter
42 Turn
44 Single winding
46 Multiple winding
50 Power tool
60 Electric motor
62 Internal rotor motor
64 External rotor motor
70 Energy supply device
72 Energy storage cells of the energy supply device
100 System

1-14. (canceled)

15. An electric motor for a power tool, the electric motor comprising:
a stator with an inner opening for receiving a rotor, the inner opening having a diameter corresponding to a stator inner diameter, the stator having a series of pole teeth each wound with a winding to form a coil, the winding being characterized by a reference diameter, a ratio of the reference diameter of the winding to the stator inner diameter multiplied by a number of pole teeth being greater than 0.3.

16. The electric motor as recited in claim 15 wherein the reference diameter corresponds to the diameter of a single conductor if the single conductor has a circular cross section and the winding has just one single conductor.

17. An electric motor for a power tool, the electric motor comprising:
a stator with an inner opening for receiving a rotor, the inner opening having a diameter corresponding to a stator inner diameter, the stator having a series of pole teeth each wound with a winding to form a coil, a ratio formed from a sum of the total winding conductor cross sections and a free winding cross section, the ratio being multiplied by a number of pole teeth so that a product is greater than 2.2.

18. The electric motor as recited in claim 17 wherein the product is greater than 2.5.

19. The electric motor as recited in claim 17 wherein the product is greater than greater than 2.8.

20. The electric motor as recited in claim 17 wherein a number of pole teeth is in a range of two to twelve.

21. The electric motor as recited in claim 17 wherein a number of pole teeth is in a range of four to ten

22. The electric motor as recited in claim 17 wherein a number of pole teeth is in a range of between six and eight.

23. The electric motor as recited in claim 17 wherein the electric motor is segmented, a number of the segments of the electric motor being in a range of two to twelve.

24. The electric motor as recited in claim 17 wherein the electric motor is segmented, a number of the segments of the electric motor being in a range of four to ten.

25. The electric motor as recited in claim 17 wherein the electric motor is segmented, a number of the segments of the electric motor being in a range of between six and eight.

26. A power tool comprising the electric motor as recited in claim 17.

27. The power tool as recited in claim 26 wherein the power tool is detachably connectable to an energy supply device, the energy supply device being designed to supply the power tool with electrical energy.

28. A system comprising the power tool as recited in claim 26 and an energy supply device, the energy supply device including at least one energy storage cell, the at least one energy storage cell having an internal resistance DCR_I of less than 10 milliohms.

29. The system as recited in claim 28 wherein the at least energy storage cell has a surface A and a volume V, a surface-to-volume ratio A/V being greater than six times the reciprocal of the cube root of the volume.

30. The system as recited in claim 28 wherein the at least energy storage cell has a surface A and a volume V, a surface-to-volume ratio A/V being greater than eight times the reciprocal of the cube root of the volume.

31. The system as recited in claim 28 wherein the at least energy storage cell has a surface A and a volume V, a surface-to-volume ratio A/V being greater than ten times the reciprocal of the cube root of the volume.

32. The system as recited in claim 28 wherein a ratio of a resistance of the at least one energy storage cell to a surface A of the at least one energy storage cell is less than 0.2 milliohms/cm².

33. The system as recited in claim 28 wherein a ratio of a resistance of the at least one energy storage cell to a surface A of the at least one energy storage cell is less than 0.1 milliohms/cm².

34. The system as recited in claim 28 wherein a ratio of a resistance of the at least one energy storage cell to a surface A of the at least one energy storage cell is less than 0.05 milliohms/cm².

35. The system as recited in claim 28 wherein the energy supply device has a capacity of at least 2.2 Ah.

36. The system as recited in claim 28 wherein the energy supply device has a capacity of at least at least 2.5 Ah.

37. The system as recited in claim 28 wherein a ratio of the reference diameter of the winding of the electric motor to the stator inner diameter of the electric motor multiplied by the number of pole teeth and the reciprocal of the internal resistance DCR_I of an energy storage cell of the energy supply device is greater than 0.03 (milliohms)⁻¹.

38. The system as recited in claim 28 wherein a ratio of the sum of the total winding conductor cross sections of the electric motor and the sum of the free winding cross sections is multiplied by a number of pole teeth and the reciprocal value of the internal resistance DCR_I of an energy storage cell of the energy supply device so that a product is greater than 0.22 (milliohms)⁻¹.
